(19) United States
(12) Patent Application Publication
(10) Pub. No.: US 2026/0270202 A1
(43) Pub. Date: Sep. 10, 2026

(54) COMMUNICATION SYSTEM, COMMUNICATION DEVICE, COMMUNICATION METHOD, AND PROGRAM

(71) Applicant: NTT, INC., Tokyo (JP)

(72) Inventors: Tomoya KOSUGI, Tokyo (JP); Shinichi YOSHIHARA, Tokyo (JP)

(73) Assignee: NTT, INC., Tokyo (JP)

(21) Appl. No.: 19/489,252

(22) PCT Filed: Jun. 1, 2023
(86) PCT No.: PCT/JP2023/020547

§ 371 Date: Dec. 1, 2025

(51) Int. Cl. H04L 45/74

(52) U.S. Cl. CPC H04L 45/74

(57) ABSTRACT

A communication system (1) according to the present disclosure includes a recording unit (11), a processing unit (12), and an inspection packet processing unit (13), in which: the processing unit (12) refers to a table in which a line ID, an address of a communication device, and an SID are associated with each other and creates an SID list including a first SID and a second SID associated with line IDs of lines of a forwarding source and a forwarding destination; the inspection packet processing unit (13) generates and transmits an inspection packet for each of a plurality of destination addresses, the inspection packet including the second SID included in the SID list and an indication value of the number of times of forwarding the packet; the inspection packet processing unit (13) extracts a transmission source address of a reply packet transmitted from another communication device that has received the inspection packet and records the transmission source address in the recording unit (11); and the processing unit (12) increments the indication value until an address associated with the second SID is extracted as the transmission source address of the reply packet.

### TECHNICAL FIELD

The present disclosure relates to a communication system, a communication device, a communication method, and a program.

### BACKGROUND ART

In a communication system that forwards a packet between a plurality of communication devices such as routers, there is a method called segment routing (SR) as a method of designating a path through which a packet passes. SR is a method of designating a path through which a packet passes by designating a communication device or a link between communication devices.

Non Patent Literature 1 discloses a function called Traceroute in SR (SR Traceroute). SR Traceroute is a function of inspecting reachability of a packet to a given destination IP address (a forwarding path of a packet to a given destination address) in a communication network to which SR is applied.

FIG. 12 shows SR Traceroute. FIG. 12 shows an example where a router X and a router A are connected, the router A and routers B and D are connected, and a router C and the routers B and D are connected.

In SR Traceroute, a network operator executes a command for a given IP address (in the example of FIG. 12, an address of the router C 3.3.3.3) from an arbitrary router (in the example of FIG. 12, the router X).

The router X records a forwarding table in advance. As shown in FIG. 12, the forwarding table is a table in which a destination IP address, a segment ID (SID) for identifying a router corresponding to the destination IP address, and an output interface (IF) for outputting a packet addressed to the router are associated with each other.

When receiving the command, the router X refers to the forwarding table and creates an SID list according to the given IP address. The SID list is a list in which SIDs are arranged in order from a forwarding source to a forwarding destination of a packet. The router X generates an inspection packet of FIG. 13A. An address of the router X is set to a source address (SA) indicating a transmission source of the inspection packet, and an address of the router C designated by the command is set to a destination address (DA) indicating a transmission destination. The inspection packet includes the created segment list and time to live (TTL). TTL is an indication value indicating the number of times of forwarding a packet.

The router X first sets a value of TTL to 1 and transmits the generated inspection packet to a communication network.

The router A, which is connected to the router X, decrements the value of TTL by one when receiving the inspection packet. Because the value of TTL is set to 1 as described above, the value of TTL becomes 0 when the value of TTL is decremented by one. When the value of TTL becomes 0, the router A does not forward the inspection packet, generates a reply packet in which the address of the router A is set to the SA and the address of the router X is set to the DA, and transmits the reply packet to the router X as shown in FIG. 13B.

The router X increments the value of TTL and transmits the inspection packet until receiving a reply packet from the router C.

### CITATION LIST

### Non Patent Literature

Non Patent Literature 1: Internet Engineering Task Force (IETF) RFC 8287, [searched on May 19, 2023], Internet <URL: https://www.rfc-editor.org/rfc/pdfrfc/rfc8287.txt.pdf>

### SUMMARY OF INVENTION

### Technical Problem

In a communication network in which a packet is forwarded between a plurality of communication devices, multipath such as equal cost multipath (ECMP) is set in some cases. In this case, a packet is allocated to a specific path among a plurality of paths and is forwarded according to a destination address or the like of the packet.

As described above, in the technique disclosed in Non Patent Literature 1, an IP address of a router designated by a command is set to the DA of an inspection packet. Therefore, in a case where multipath is set, the inspection packet is forwarded only to a specific path, and thus all routers through which the packet can pass cannot be inspected.

It is also conceivable to set any of various destination addresses to the DA of the inspection packet in order to inspect all the routers through which the packet can pass even in a case where multipath is set. In this case, however, an SID list cannot be created in a case where the set destination address is not registered in a forwarding table.

An object of the present disclosure that has been made in view of the above problems is to provide a communication system, a communication device, and a program capable of reducing omission of inspection of a communication device through which a packet can pass even in a case where multipath is set.

### Solution to Problem

In order to solve the above problems, a communication system according to the present disclosure is a communication system in which a packet is forwarded between a plurality of communication devices, the communication system including a recording unit, a processing unit that inspects a forwarding path of the packet, and an inspection packet processing unit provided in the communication device, in which: the recording unit records a table in which a line ID for identifying a line accommodated in each of the plurality of communication devices, an address of the communication device that accommodates the line identified by the line ID, and a segment ID (SID) for identifying the communication device that accommodates the line identified by the line ID are associated with each other; the processing unit refers to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet; the inspection packet processing unit generates and transmits, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet; the inspection packet processing unit extracts a transmission source address of a reply packet transmitted from another communication device that has received the inspection packet and records the extracted transmission source address in the recording unit as an inspection result of the forwarding path of the packet; and the processing unit increments the indication value until an address associated with the second SID is extracted as the transmission source address of the reply packet.

In order to solve the above problems, a communication device according to the present disclosure is a communication device that forwards a packet to another communication device, the communication device including a recording unit, a processing unit that inspects a forwarding path of the packet, and an inspection packet processing unit, in which: the recording unit records a table in which a line ID for identifying a line accommodated in each of the plurality of communication devices including the another communication device and the own device, an address of the communication device that accommodates the line identified by the line ID, and a segment ID (SID) for identifying the communication device that accommodates the line identified by the line ID are associated with each other; the processing unit refers to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet; the inspection packet processing unit generates, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet; the inspection packet processing unit extracts a transmission source address of a reply packet transmitted from another communication device that has received the inspection packet; the processing unit records the extracted transmission source address in the recording unit as an inspection result of the forwarding path of the packet; and the inspection packet processing unit increments the indication value until an address associated with the second SID is extracted as the transmission source address of the reply packet.

In order to solve the above problems, a communication method according to the present disclosure is a communication method by a communication device that forwards a packet to another communication device, the communication method including: a step of recording a table in which a line ID for identifying a line accommodated in each of the plurality of communication devices including the another communication device and the own device, an address of the communication device that accommodates the line identified by the line ID, and a segment ID (SID) for identifying the communication device that accommodates the line identified by the line ID are associated with each other; a step of referring to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet; a step of generating, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet; a step of extracting a transmission source address of a reply packet transmitted from another communication device that has received the inspection packet; a step of recording the extracted transmission source address as an inspection result of the forwarding path of the packet; and a step of incrementing the indication value until an address associated with the second SID is extracted as the transmission source address of the reply packet.

In order to solve the above problems, a program according to the present disclosure causes a computer to operate as the above communication device.

### Advantageous Effects of Invention

In a communication system, a communication device, a communication method, and a program according to the present disclosure, it is possible to reduce omission of inspection of a communication device through which a packet can pass even in a case where multipath is set.

### BRIEF DESCRIPTION OF DRAWINGS

FIG. 1 shows a configuration example of a communication system according to an embodiment of the present disclosure.

FIG. 2 shows a configuration example of a line ID-accommodation device correspondence table recorded by a recording unit in FIG. 1.

FIG. 3 shows a configuration example of a DA table recorded by the recording unit in FIG. 1.

FIG. 4 is a flowchart showing an example of an operation of a PE router 10 in FIG. 1.

FIG. 5 shows a configuration example of a head-tail table created by a processing unit in FIG. 1.

FIG. 6 is a flowchart showing an example of an operation of inspecting a forwarding path of a packet by the PE router 10 in FIG. 1.

FIG. 7 shows a configuration example of a DA reply table created by the processing unit in FIG. 1.

FIG. 8 shows a configuration example of an aggregate result table created by the processing unit in FIG. 1.

FIG. 9 shows another configuration example of a communication system according to an embodiment of the present disclosure.

FIG. 10 is a flowchart showing another example of an operation of inspecting a forwarding path of a packet by the PE router 10 in FIG. 1.

FIG. 11 shows a configuration example of a computer that functions as a communication device or an external device according to the present disclosure.

FIG. 12 shows SR Traceroute.

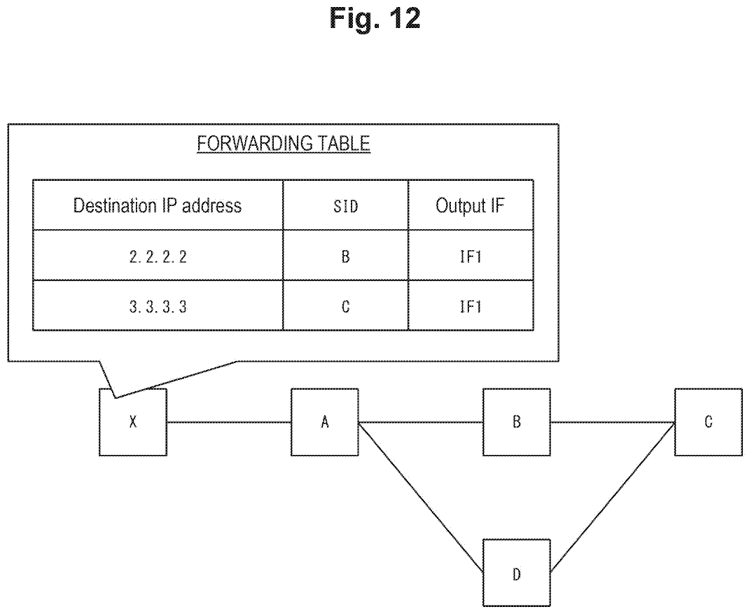

FIG. 13A shows a configuration example of an inspection packet.

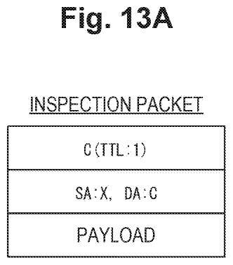

FIG. 13B shows a configuration example of a reply packet.

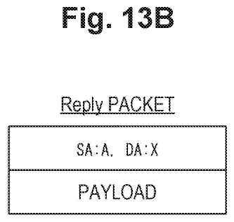

### DESCRIPTION OF EMBODIMENTS

Hereinafter, an embodiment of the present disclosure will be described with reference to the drawings.

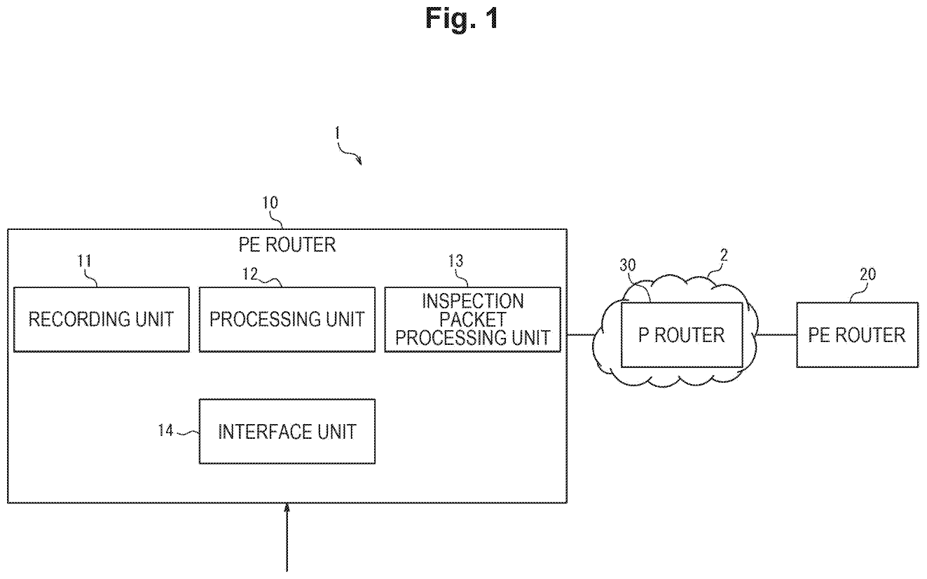

FIG. 1 shows a configuration example of a communication system 1 according to an embodiment of the present disclosure. The communication system 1 according to the present embodiment forwards a packet between a plurality of communication devices such as routers. The communication system 1 is, for example, a system that provides a communication service such as a Layer 2 Virtual Private Network (L2VPN) for a client.

As shown in FIG. 1, the communication system 1 according to the present embodiment includes provider edge (PE) routers 10 and 20 connected to a communication network 2. The PE routers 10 and 20 are routers provided by a communications carrier that provides the communication service and are located at a boundary between a network on the client side (e.g. LAN) and the communication network 2 on the communications carrier side such as a broadband network. The communication network 2 includes one or a plurality of provider (P) routers 30 and the like. The P router 30 forwards a packet in the communication network 2. Although FIG. 1 shows an example where the PE router 10 and the PE router 20 are connected via the communication network 2 including the P router 30 and the like, the PE router 10 and the PE router 20 may be directly connected.

Next, a configuration of the PE router 10 serving as a communication device according to the present embodiment will be described with reference to FIG. 1. FIG. 1 shows a configuration regarding inspection of a forwarding path of a packet among configurations of the PE router 10, and description of the other configurations is omitted. The PE router 20 and the P router 30 are general routers, and thus description thereof is omitted.

As shown in FIG. 1, the PE router 10 serving as the communication device according to the present embodiment includes a recording unit 11, a processing unit 12, an inspection packet processing unit 13, and an interface unit 14.

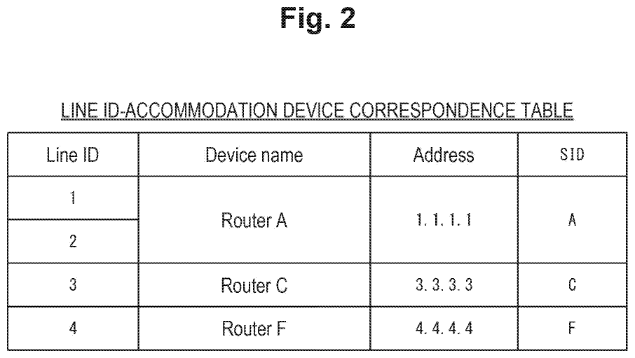

The recording unit 11 records various tables. The recording unit 11 records, for example, a line ID-accommodation device correspondence table in FIG. 2.

As shown in FIG. 2, the line ID-accommodation device correspondence table is a table in which a line ID, a device name, an address, and an SID are associated with each other. The line ID is an identifier for identifying a line that is accommodated in each of a plurality of communication devices (PE routers 10 and 20) that forwards a packet in the communication system 1 and is allocated to each client who receives the communication service. One communication device accommodates a plurality of lines in some cases. In this case, as shown in FIG. 2, a plurality of line IDs is associated with one communication device. The device name is a device name of the communication device that accommodates the line identified by the line ID. The address is an address of the communication device that accommodates the line identified by the line ID. The SID is an SID for identifying the communication device that accommodates the line identified by the line ID. Note that the device name is not essential and may be substituted by the address or the SID.

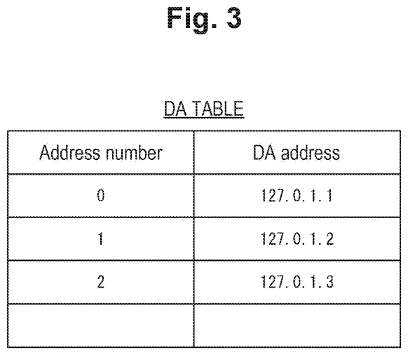

The recording unit 11 records a DA table in FIG. 3.

As shown in FIG. 3, the DA table is a table in which an address number and a DA address are associated with each other. The DA address is any preset address.

Referring back to FIG. 1, the processing unit 12 inspects a forwarding path of a packet.

The inspection packet processing unit 13 generates an inspection packet and transmits the inspection packet to the communication network 2. The inspection packet processing unit 13 receives a reply packet transmitted from another communication device that has received an inspection packet and extracts an address set to the SA of the reply packet.

The interface unit 14 receives data input from the outside. For example, the interface unit 14 receives input of the line ID recorded in the line ID-accommodation device correspondence table, the DA address recorded in the DA table, and the like.

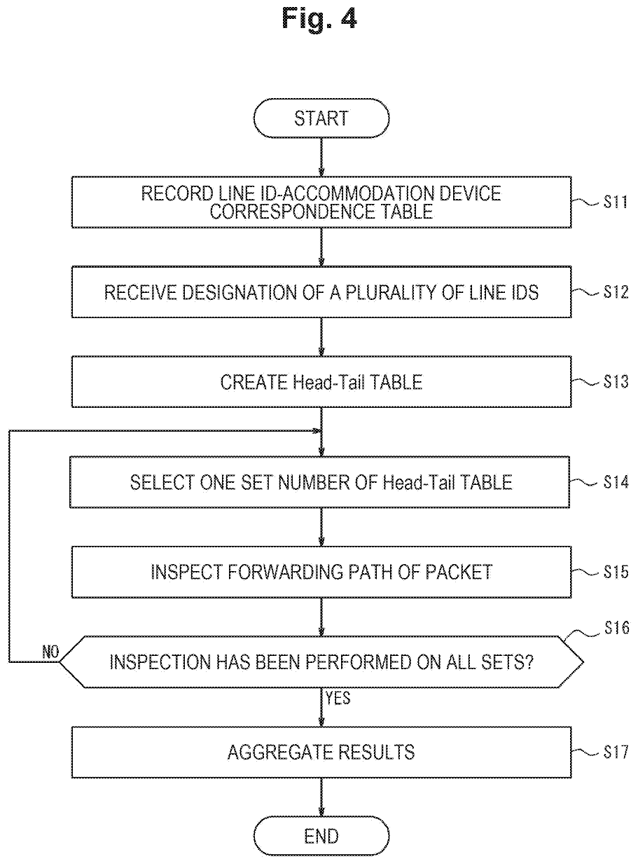

Next, an operation of the PE router 10 serving as the communication device according to the present embodiment will be described with reference to FIG. 4.

FIG. 4 is a flowchart showing an example of the operation of the PE router 10 and shows a communication method by the PE router 10.

As a preliminary preparation, the recording unit 11 records the line ID-accommodation device correspondence table described with reference to FIG. 2 (step S11).

The interface unit 14 receives selection of a plurality of line IDs (line IDs of lines of a forwarding source and forwarding destination of a packet) from a network operator (step S12). The number of selected line IDs may be three or more. In this case, for example, a plurality of line IDs may be selected as the line ID of the line of the forwarding destination of the packet.

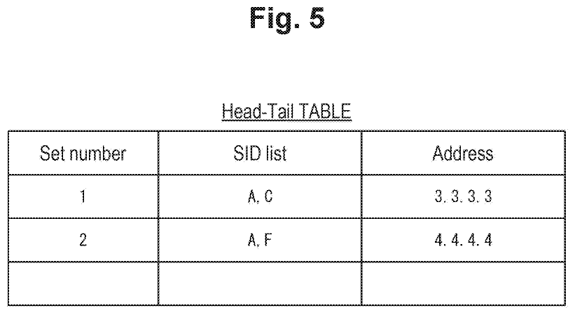

The processing unit 12 refers to the line ID-accommodation device correspondence table, creates a head-tail table in FIG. 5 on the basis of the plurality of selected line IDs (step S13), and records the head-tail table in the recording unit 11.

As shown in FIG. 5, the head-tail table is a table in which a set number, an SID list, and an address are associated with each other. The set number is a number given to each set of the forwarding source and forwarding destination of the packet.

The SID list is a list in which SIDS of communication devices from the forwarding source to the forwarding destination of the packet are arranged in order from the forwarding source to the forwarding destination of the packet. As described with reference to FIG. 2, the line ID and the SID of the communication device accommodating the line identified by the line ID are recorded in association with each other in the line ID-accommodation device correspondence table. Therefore, in the present embodiment, the processing unit 12 can specify an SID list corresponding to the selected line IDs by referring to the line ID-accommodation device correspondence table. For example, the processing unit 12 can create an SID list on the basis of a multi-protocol label switching (MPLS) label, header information of IPV6, or the like.

As described above, the processing unit 12 refers to the line ID-accommodation device correspondence table to create an SID list in which SIDs including an SID (first SID) associated with the line ID of the line of the forwarding source of the packet and an SID (second SID) associated with the line ID of the line of the forwarding destination of the packet are arranged in order from the forwarding source to the forwarding destination of the packet.

The address is an address of a communication device identified by the SID at the end of the SID list, that is, a communication device accommodating the line of the forwarding destination of the packet.

Referring back to FIG. 4, the processing unit 12 selects one set number of the created head-tail table (step S14).

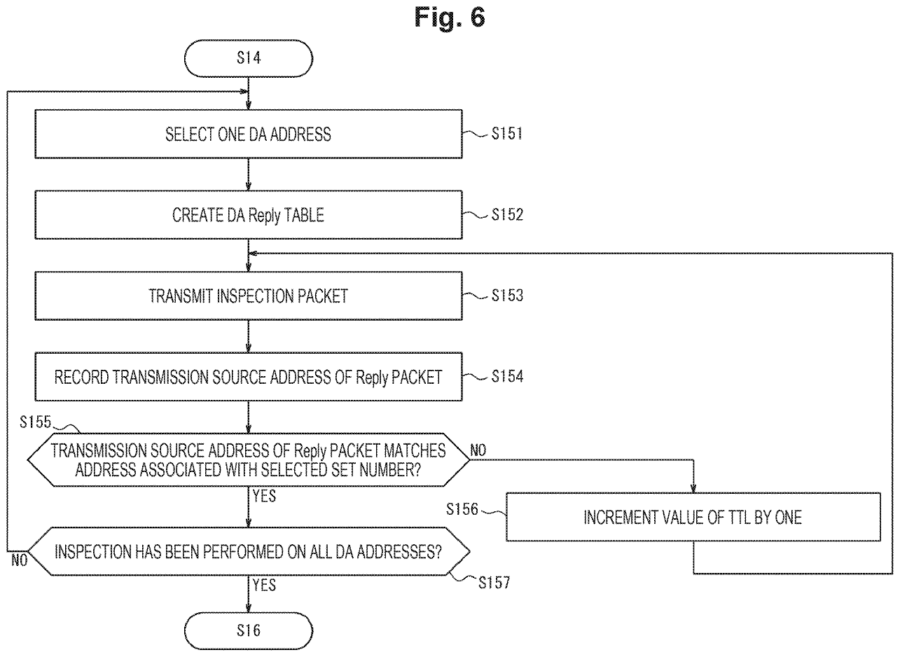

The processing unit 12 inspects the forwarding path of the packet for the selected set number (step S15). The inspection of the forwarding path of the packet will be described in detail with reference to FIG. 6.

FIG. 6 is a flowchart showing an example of an operation of inspecting the forwarding path of the packet by the PE router 10 in FIG. 1.

As a preliminary preparation, the recording unit 11 records the DA table described with reference to FIG. 3.

The processing unit 12 selects one DA address from the DA table recorded in the recording unit 11 (step S151). For example, the processing unit 12 selects a DA address corresponding to the address number in ascending order of the address number.

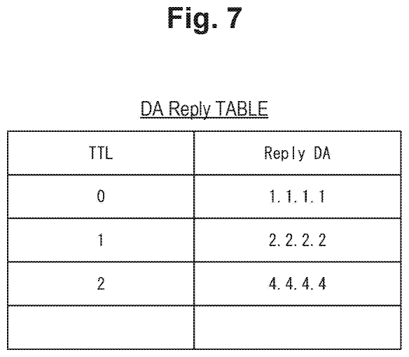

The processing unit 12 creates a DA reply table corresponding to the selected DA address and records the DA reply table in the recording unit 11 (step S152). FIG. 7 shows an example of the DA reply table.

As shown in FIG. 7, the DA reply table is a table in which TTL and the reply DA are associated with each other. TTL is an indication value indicating the number of times of forwarding a packet. The reply DA is an address set to the SA of a reply packet transmitted from another communication device in response to transmission of an inspection packet in which the corresponding TTL is set to the communication network 2.

The processing unit 12 sets the value of TTL to 1. The reason why the value of TTL is set to 1 is that the value of TTL becomes 0 in another communication device (in FIG. 1, the P router 30) adjacent to the PE router 10 so as to cause another communication device to transmit a reply packet.

The inspection packet processing unit 13 generates an inspection packet and transmits the inspection packet to the communication network 2 (step S153). In the line ID-accommodation device correspondence table, the inspection packet processing unit 13 sets the address associated with the first SID (SID associated with the line ID of the line of the forwarding source of the packet) to the SA of the inspection packet and sets the DA address selected in step S151 to the DA of the inspection packet. The inspection packet processing unit 13 also sets the value of TTL set by the processing unit 12 to the inspection packet. The inspection packet processing unit 13 includes, in the inspection packet, the second SID included in the SID list associated with the set number selected in step S14 in the head-tail table. Note that the inspection packet processing unit 13 sets information conforming to RFC 8287 or the like to other fields and payloads of the inspection packet.

When the value of TTL becomes 0, another communication device that has received the inspection packet transmits a reply packet to the PE router 10. An address of the communication device that transmits the reply packet is set to the SA of the reply packet, and the address of the PE router 10 is set to the DA of the reply packet.

The inspection packet processing unit 13 receives the reply packet transmitted from another communication device. The inspection packet processing unit 13 extracts an address (transmission source address) set to the SA of the received reply packet.

The inspection packet processing unit 13 records the extracted transmission source address of the reply packet in the reply DA of the DA reply table as an inspection result (step S154). Specifically, the inspection packet processing unit 13 records the address extracted from the reply packet transmitted from another communication device in response to the inspection packet in association with the value of TTL set to the inspection packet. In some cases, no reply packet is received for a predetermined time or more after the inspection packet is transmitted. In this case, the fact that no response has been obtained may be registered in the DA reply table, and the processing may return to the processing in step S151.

Next, the processing unit 12 determines whether or not the transmission source address of the reply packet matches the address associated with the set number selected in step S14 in the head-tail table (step S155).

If it is determined that the transmission source address of the reply packet does not match the address associated with the set number (step S155: No), the processing unit 12 increments the value of TIL by one (step S156). The processing unit 12 increments the value of TTL until the address associated with the selected set number (address associated with the second SID) is extracted as the transmission source address of the reply packet. Thereafter, the inspection packet processing unit 13 returns to the processing in step S153.

If it is determined that the transmission source address of the reply packet matches the address associated with the set number (step S155: Yes), the processing unit 12 determines whether or not the inspection (processing from steps S152 to S156) has been performed on all the DA addresses recorded in the DA table (step S157).

If it is determined that the inspection has not been performed on all the DA addresses (step S157: No), the processing unit 12 returns to the processing in step S151. The processing unit 12 does not select the same DA address redundantly, for example, by selecting a DA address corresponding to a set number larger by one than the currently selected set number.

If it is determined that the inspection has been performed on all the DA addresses (step S157: Yes), the processing unit 12 proceeds to the processing in step S16.

As described above, in a case where multipath such as ECMP is set, a packet is allocated to a specific path among a plurality of paths and is forwarded according to a destination address or the like of the packet. In the present embodiment, the inspection is performed on each of the plurality of DA addresses recorded in the DA table. This makes it possible to reduce a possibility that the inspection packet is allocated only to a specific path. As a result, even in a case where multipath is set, it is possible to reduce omission of inspection of a communication device through which a packet can pass.

Referring back to FIG. 4, the processing unit 12 determines whether or not the inspection has been performed on all sets recorded in the head-tail table (step S16).

If it is determined that the inspection has not been performed on all the sets (step S16: No), the processing unit 12 returns to step S14.

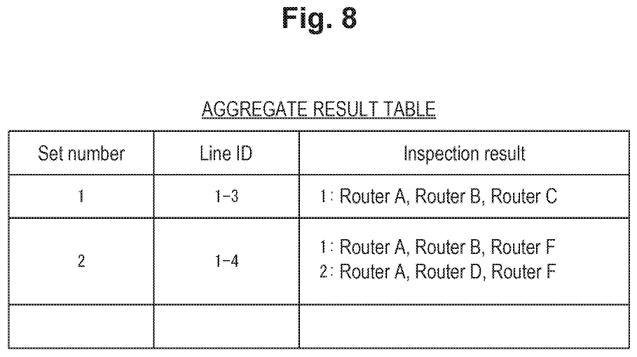

If it is determined that the inspection has been performed on all the sets (step S16: Yes), the processing unit 12 aggregates the inspection results (step S17) and outputs an aggregate result table showing the aggregate results. FIG. 8 shows an example of the aggregate result table.

As shown in FIG. 8, the aggregate result table is a table in which a set number, a line ID, and a forwarding path are associated with each other. The set number is the same as the set number of the head-tail table. The line ID indicates the line IDs of the lines of the forwarding source and forwarding destination of the packet. The line ID can be obtained by referring to the address recorded in the head-tail table and the line ID recorded in the line ID-accommodation device correspondence table.

The inspection result shows device names of communication devices included in the forwarding path of the packet between the lines of the forwarding source and forwarding destination of the packet specified by the line IDs in order from the forwarding source to the forwarding destination of the packet. The forwarding path can be obtained by referring to the address shown in the DA reply table and the device name recorded in the line ID-accommodation device correspondence table.

In some cases, there is a plurality of forwarding paths of the packet between the line of the forwarding source of the packet and the line of the forwarding destination of the packet. In this case, as shown in FIG. 8, the processing unit 12 may output, for each of the plurality of forwarding paths, the device names included in the forwarding path as the inspection result.

FIG. 1 shows an example where the PE router 10 includes the recording unit 11, the processing unit 12, and the inspection packet processing unit 13, but the present invention is not limited thereto.

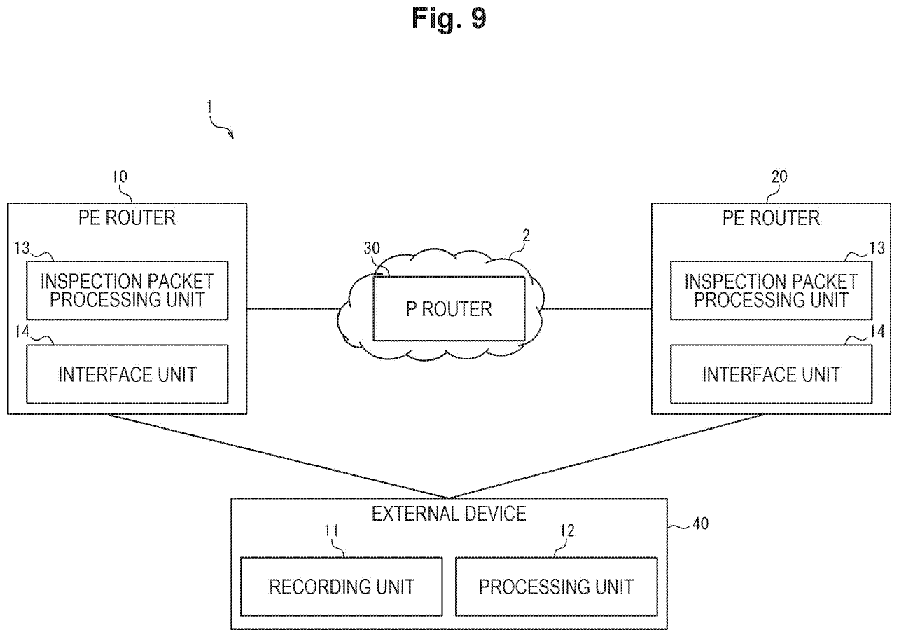

FIG. 9 shows another configuration example of the communication system 1 according to the present embodiment. In the communication system 1 of FIG. 9, an external device 40 is added as compared with the communication system 1 of FIG. 1.

The external device 40 is connected to a plurality of communication devices. FIG. 9 shows an example where the external device 40 is connected to the PE router 10 and the PE router 20. The external device 40 includes a table synchronized with a forwarding table or a routing table included in the communication device connected thereto. For example, the external device 40 can synchronize routing information with another communication device by using an existing routing protocol such as a border gateway protocol (BGP) or an interior gateway protocol (IGP). The external device 40 may be connected to both the PE routers 10 and 20 or only one of the PE routers 10 and 20. The external device 40 and the PE router 10 may be directly connected or connected via a communication network.

As shown in FIG. 9, the external device 40 includes the recording unit 11 and the processing unit 12. Each of the PE routers 10 and 20 includes the inspection packet processing unit 13 and the interface unit 14.

In the communication system 1 of FIG. 9, the SID list necessary for generating an inspection packet, the value of TTL, and the like are transmitted from the external device 40 to the PE routers 10 and 20 that generate and transmit an inspection packet. A transmission source address extracted by the inspection packet processing unit 13 included in the PE router 10 or 20 and set to the SA of a reply packet is transmitted to the external device 40. The external device 40 may have a function of processing the reply packet (extracting the address set to the SA of the reply packet).

In FIG. 4, there has been described an example where the processing unit 12 inspects a forwarding path of a packet in response to designation of a plurality of line IDs by a user (network operator), but the present invention is not limited thereto. The processing unit 12 may inspect the forwarding path of the packet at a given frequency for each pair obtained by combining the line IDs recorded in the line ID-accommodation device correspondence table. In this case, the inspection results of the path may be recorded in the recording unit 11, and when the user (network operator) designates a plurality of line IDs, the inspection result recorded in the recording unit 11 for a pair of the designated line IDs may be output. This makes it possible to quickly output the inspection result in response to input from the user.

In FIG. 4, the processing ends when the forwarding path of the packet is inspected once, but the present invention is not limited thereto, and the forwarding path of the packet may be inspected a plurality of times.

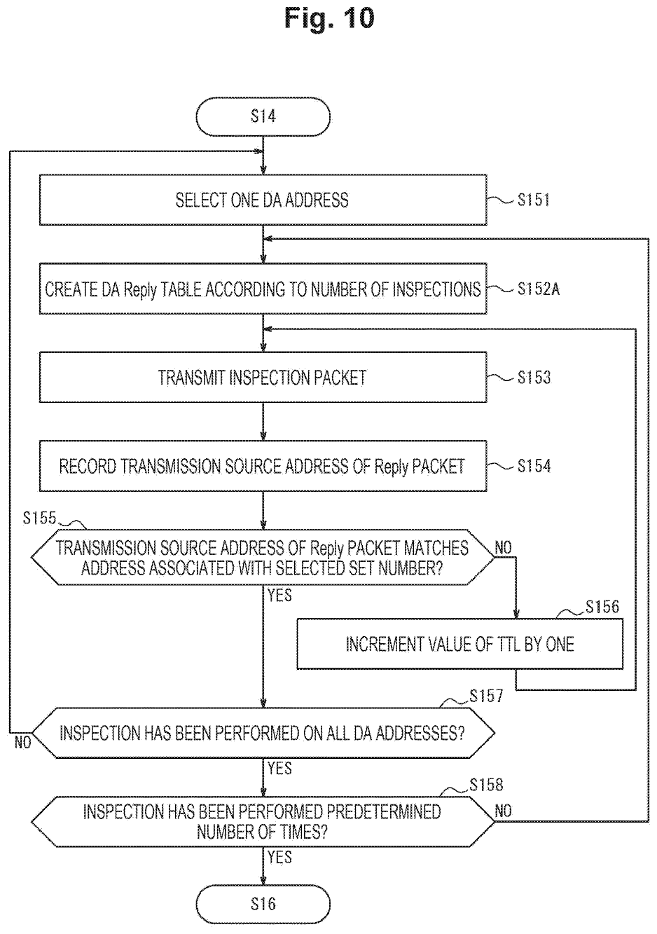

FIG. 10 is a flowchart showing an example of an operation of the PE router 10 in a case where the forwarding path of the packet is inspected a plurality of times. In FIG. 10, processing similar to the processing in FIG. 6 is denoted by the same reference signs, and description thereof is omitted.

The processing unit 12 creates a DA reply table according to the number of inspections (step S152A).

If it is determined that the inspection has been performed on all the DA addresses (step S157: Yes), the processing unit 12 determines whether or not the inspection has been performed a predetermined number of times (step S158).

If it is determined that the inspection has not been performed the predetermined number of times (step S158: No), the processing unit 12 returns to step S152A.

If it is determined that the inspection has been performed the predetermined number of times (step S158: Yes), the processing unit 12 proceeds to step S16.

By performing the inspection a plurality of times, for example, it is possible to confirm temporal progress of the forwarding path of the packet. Further, by performing the inspection a plurality of times, for example, statistical processing may be performed, such as generation of a histogram of an appearance frequency of a combination of the forwarding path of the packet and the line ID of the aggregate result table.

As described above, the communication system 1 according to the present embodiment includes the recording unit 11, the processing unit 12 that inspects a forwarding path of a packet, and the inspection packet processing unit 13 provided in a communication device.

The recording unit 11 records a line ID-accommodation device correspondence table in which a line ID for identifying a line accommodated in each of a plurality of communication devices, an address of the communication device that accommodates the line identified by the line ID, and an SID for identifying the communication device that accommodates the line identified by the line ID are associated with each other. The processing unit 12 refers to the line ID-accommodation device correspondence table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet. The inspection packet processing unit 13 generates and transmits, for each of a plurality of preset destination addresses (DA addresses), an inspection packet in which the destination address is set as the forwarding destination and an address associated with the first SID is set as the forwarding source. Here, the inspection packet includes the second SID included in the created SID list and an indication value (TTL) indicating the number of times of forwarding the packet. The inspection packet processing unit 13 extracts a transmission source address of a reply packet transmitted from another communication device that has received the inspection packet and records the extracted transmission source address in the recording unit 11 as an inspection result of the forwarding path of the packet. The processing unit 12 increments the indication value until an address associated with the second SID is extracted as the transmission source address of the reply packet.

By preparing the line ID-accommodation device correspondence table in which the line ID and the SID of the communication device are associated with each other in advance, it is possible to create an SID list from the line IDs of the lines of the transmission source and the transmission destination of the packet. Therefore, the SID list can be created also in a case where an arbitrary address is set to the DA of the inspection packet. By creating the inspection packet for the plurality of DA addresses, it is possible to reduce a possibility that the inspection packet is allocated only to a specific path. As a result, even in a case where multipath is set, it is possible to reduce omission of inspection of a communication device through which a packet can pass.

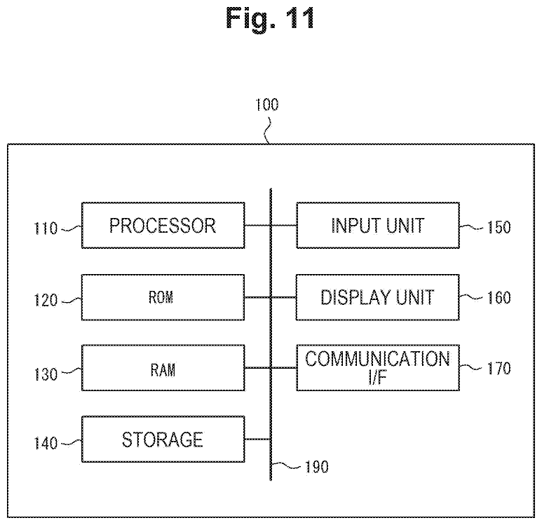

The PE router 10 and the external device 40 described above can be implemented by, for example, a computer 100 in FIG. 11. A program for causing the computer 100 to function as the PE router 10 or the external device 40 may be provided. The program may be stored in a storage medium or may be provided via a network. FIG. 11 is a block diagram showing a schematic configuration of the computer 100 that functions as the PE router 10 or the external device 40. The computer 100 may be a general-purpose computer, a dedicated computer, a workstation, a personal computer (PC), an electronic note pad, or the like. Program instructions may be program codes, code segments, or the like for performing required tasks.

As shown in FIG. 11, the computer 100 includes a processor 110, a read only memory (ROM) 120, a random access memory (RAM) 130, a storage 140, an input unit 150, a display unit 160, and a communication interface (I/F) 170. The components are communicably connected to each other via a bus 190. Specifically, the processor 110 is a central processing unit (CPU), a micro processing unit (MPU), a graphics processing unit (GPU), a digital signal processor (DSP), a system on a chip (SoC), or the like and may include a plurality of processors of the same type or different types.

The processor 110 is a control unit that executes control of the components and various types of arithmetic processing. That is, the processor 110 reads a program from the ROM 120 or the storage 140 and executes the program by using the RAM 130 as a working area. The processor 110 executes control of the components and various types of arithmetic processing according to the program stored in the ROM 120 or the storage 140. In the present embodiment, the ROM 120 or the storage 140 stores a program for causing the computer 100 to operate as the PE router 10 (communication device) or the external device 40 according to the present disclosure. By the processor 110 reading and executing the program, the components of the PE router 10 (communication device) or the external device 40 described above is implemented.

The program may be provided in a form of being stored in a non-transitory storage medium, such as a compact disk read only memory (CD-ROM), a digital versatile disk read only memory (DVD-ROM), or a universal serial bus (USB) memory. The program may be downloaded from the external device via a network.

The ROM 120 stores various programs and various types of data. The RAM 130 temporarily stores programs or data as a work area. The storage 140 includes a hard disk drive (HDD) or a solid state drive (SSD) and stores various programs including an operating system and various types of data.

The input unit 150 includes a pointing device such as a mouse and a keyboard and is used to perform various inputs.

The display unit 160 is, for example, a liquid crystal display and displays various types of information. The display unit 160 may function as the input unit 150 by employing a touch panel system.

The communication interface 170 is an interface for communicating with another device.

Regarding the above embodiment, the following Supplementary notes are further disclosed.

### [Supplementary Note 1]

A communication system in which a packet is forwarded between a plurality of communication devices, the communication system including
a recording unit, a processing unit that inspects a forwarding path of the packet, and an inspection packet processing unit provided in the communication device, in which:
the recording unit records a table in which a line ID for identifying a line accommodated in each of the plurality of communication devices, an address of the communication device that accommodates the line identified by the line ID, and a segment ID (SID) for identifying the communication device that accommodates the line identified by the line ID are associated with each other;
the processing unit refers to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet;
the inspection packet processing unit generates and transmits, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet;
the inspection packet processing unit extracts a transmission source address of a reply packet transmitted from another communication device that has received the inspection packet and records the extracted transmission source address in the recording unit as an inspection result of the forwarding path of the packet; and
the processing unit increments the indication value until an address associated with the second SID is extracted as the transmission source address of the reply packet.

### [Supplementary Note 2]

The communication system according to supplementary note 1, in which
the recording unit, the processing unit, and the inspection packet processing unit are provided in the same communication device.

### [Supplementary Note 3]

The communication system according to supplementary note 2, further including
an external device connected to each of the plurality of communication devices, in which
the recording unit and the processing unit are provided in the external device.

### [Supplementary Note 4]

The communication system according to any one of supplementary notes 1 to 3, in which
the processing unit inspects the forwarding path of the packet in response to designation of a plurality of line IDs by a user.

### [Supplementary Note 5]

The communication system according to any one of supplementary notes 1 to 3, in which
the processing unit inspects the forwarding path of the packet at a given frequency for each pair obtained by combining the line IDs stored in the table.

### [Supplementary Note 6]

A communication device that forwards a packet to another communication device, the communication device including
a recording unit and a control unit, in which:
the recording unit records a table in which a line ID for identifying a line accommodated in each of a plurality of communication devices including the another communication device and the own device, an address of the communication device that accommodates the line identified by the line ID, and a segment ID (SID) for identifying the communication device that accommodates the line identified by the line ID are associated with each other; and
the control unit refers to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet,
generates, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet,
extracts a transmission source address of a reply packet transmitted from another communication device that has received the inspection packet,
records the extracted transmission source address in the recording unit as an inspection result of the forwarding path of the packet, and
increments the indication value until an address associated with the second SID is extracted as the transmission source address of the reply packet.

### [Supplementary Note 7]

A communication method by a communication device that forwards a packet to another communication device, the communication method including:
recording a table in which a line ID for identifying a line accommodated in each of a plurality of communication devices including the another communication device and the own device, an address of the communication device that accommodates the line identified by the line ID, and a segment ID (SID) for identifying the communication device that accommodates the line identified by the line ID are associated with each other;
referring to the table to create an SID list in which SIDs including a first SID associated with a line ID of a line of a forwarding source of the packet and a second SID associated with a line ID of a line of a forwarding destination of the packet are arranged in order from the forwarding source to the forwarding destination of the packet;
generating, for each of a plurality of preset destination addresses, an inspection packet in which the destination address is set as the forwarding destination and an address associated with the first SID is set as the forwarding source, the inspection packet including the second SID included in the created SID list and an indication value indicating the number of times of forwarding the packet;
extracting a transmission source address of a reply packet transmitted from another communication device that has received the inspection packet;
recording the extracted transmission source address as an inspection result of the forwarding path of the packet; and
incrementing the indication value until an address associated with the second SID is extracted as the transmission source address of the reply packet.

### [Supplementary Note 8]

A non-transitory storage medium storing a program executable by a computer, the non-transitory storage medium storing the program for causing the computer to operate as the communication device according to supplementary note 6.

Although the above embodiment has been described as a representative example, it is apparent to those skilled in the art that many changes and substitutions can be made within the spirit and scope of the present disclosure. Therefore, it should not be understood that the present invention is limited by the above embodiment, and various modifications or changes can be made without departing from the scope of the claims. For example, a plurality of configuration blocks shown in the configuration diagrams of the embodiment can be combined into one, or one configuration block can be divided.

### REFERENCE SIGNS LIST

1 Communication system
10, 20 PE router (communication device)
30 P router
40 External device
11 Recording unit
12 Processing unit
13 Inspection packet processing unit
14 Interface unit
100 Computer
110 Processor
120 ROM
130 RAM
140 Storage
150 Input unit
160 Display unit
170 Communication I/F
190 Path

1. A communication system for forwarding a packet between communication devices of a plurality of communication devices, the communication system comprising a processor executing computer-executable instructions to perform operations comprising:
identifying a forwarding path of the packet;
recording a table, wherein the table comprises:
a line identification (ID) that identifies a line accommodated in a respective communication device of the plurality of communication devices,
an address of the communication device, the address represents the line identified by the line ID, and
a segment ID (SID) for identifying the communication device that accommodates the line identified by the line ID;
creating, based on the table, an SID list, wherein the SID list comprises a first SID associated with a line ID of a line of a forwarding source of the packet and a second SID associated with a line ID of a line of a forwarding destination of the packet, and the SID list comprises segment identifications that are arranged in order from the forwarding source to the forwarding destination of the packet;
generating and transmitting, for a respective preset destination address of a plurality of preset destination addresses, an inspection packet, wherein the inspection packet comprises respective preset destination address as the forwarding destination and an address associated with the first SID as the forwarding source, and the inspection packet further comprises the second SID included in the created SID list and an indication value indicating a number of times of forwarding the packet;
extracting a transmission source address of a reply packet transmitted from another communication device that has received the inspection packet;
recording the extracted transmission source address as an inspection result of the forwarding path of the packet; and
incrementing the indication value until an address associated with the second SID is extracted as the transmission source address of the reply packet.

2. The communication system according to claim 1, wherein
the processor performing the identifying, the recording the table, the creating, the generating, the extracting, the recording the extracted transmission address, and the incrementing is a part of one communication device of the plurality of communication devices.

3. The communication system according to claim 1, further comprising
an external device connected to the respective communication device of the plurality of communication devices, wherein
the processor performing at least the identifying, the recording the table, and the creating, and the generating operations is a part of the external device.

4. The communication system according to claim 1, wherein
the identifying further comprises identifying the forwarding path of the packet in response to receiving designation of a plurality of line IDs by a user.

5. The communication system according to claim 1, wherein
the identifying further comprises identifying the forwarding path of the packet at a given frequency for each pair obtained by combining a plurality of line IDs stored in the table.

6. A communication device for forwarding a packet to another communication device, the communication device comprising a processor executing computer-executable instructions to perform operations comprising:
identifying a forwarding path of the packet;
recording a table, wherein the table comprises:
a line identification (ID) that identifies a line accommodated in a respective communication device of a plurality of communication devices,
the plurality of communication devices comprises said another communication device and the communication device,
an address of the communication device, the address represents the line identified by the line ID, and
a segment ID (SID) for identifying the communication device that accommodates the line identified by the line ID;
creating, based on the table, an SID list, wherein the SID list comprises a first SID associated with a line ID of a line of a forwarding source of the packet and a second SID associated with a line ID of a line of a forwarding destination of the packet, and the SID list comprises segment identifications that are arranged in order from the forwarding source to the forwarding destination of the packet;
generating, for a respective preset destination address of a plurality of preset destination addresses, an inspection packet, wherein the inspection packet comprises the respective preset destination address as the forwarding destination and an address associated with the first SID as the forwarding source, and the inspection packet further comprises the second SID included in the created SID list and an indication value indicating a number of times of forwarding the packet;
extracting a transmission source address of a reply packet transmitted from said another communication device that has received the inspection packet;
recording the extracted transmission source address as an inspection result of the forwarding path of the packet; and
incrementing the indication value until an address associated with the second SID is extracted as the transmission source address of the reply packet.

7. A communication method by a communication device for forwarding a packet to another communication device, the communication method comprising:
recording a table, wherein the table comprises:
a line identification (ID) that identifies a line accommodated in a respective communication device of a plurality of communication devices,
the plurality of communication devices comprises said another communication device and the communication device,
an address of the communication device, the address represents the line identified by the line ID, and
a segment ID (SID) for identifying the communication device that accommodates the line identified by the line ID;
creating, based on the table, an SID list, wherein the SID list comprises a first SID associated with a line ID of a line of a forwarding source of the packet and a second SID associated with a line ID of a line of a forwarding destination of the packet, and the SID list comprises segment identifications that are arranged in order from the forwarding source to the forwarding destination of the packet;
generating, for a respective preset destination address of a plurality of preset destination addresses, an inspection packet, wherein the inspection packet comprises the respective preset destination address as the forwarding destination and an address associated with the first SID as the forwarding source, and the inspection packet further comprises the second SID included in the created SID list and an indication value indicating a number of times of forwarding the packet;
extracting a transmission source address of a reply packet transmitted from said another communication device that has received the inspection packet;
recording the extracted transmission source address as an inspection result of the forwarding path of the packet; and
incrementing the indication value until an address associated with the second SID is extracted as the transmission source address of the reply packet.

8. A computer-readable non-transitory recording medium storing a computer-executable program instructions that when executed by a processor cause a computer to execute operations as the communication device according to claim 6.
